(19) United States
(12) Patent Application Publication
(10) Pub. No.: US 2026/0065623 A1
(43) Pub. Date: Mar. 5, 2026

(54) METHODS AND SYSTEMS USING AN ARTIFICIAL INTELLIGENCE MODEL TO ANALYZE INDICATORS

(71) Applicant: TERRAGENE LLC, Spring, TX (US)

(72) Inventors: Esteban LOMBARDÍA, Santa Fe (AR); Adrián Jesús ROVETTO, Santa Fe (AR); Maximiliano PLATIA, Santa Fe (AR); Hisashi Joaquín KONNO, Santa Fe (AR)

(21) Appl. No.: 18/821,359

(22) Filed: Aug. 30, 2024

(51) Int. Cl. G06V 10/26; G06K 19/06; G06V 10/25; G06V 10/56; G06V 10/82; G06V 10/98

(52) U.S. Cl. CPC G06V 10/273; G06V 10/25; G06V 10/56; G06V 10/82; G06V 10/993; G06K 19/06037

(57) ABSTRACT

A method for monitoring chemical indicators used in washing, disinfection and sterilization processes; a system which carries out said method; a method for quantifying cavitation energy in a cavitation indicator subjected to an ultrasonic wash cycle; and a system which carries out said method for quantifying cavitation energy, wherein each of said methods and systems uses an artificial intelligence model to analyze indicators.

### FIELD OF THE INVENTION

The present invention relates to methods and systems for the analysis of indicators. Particularly, the present invention relates to a method for monitoring chemical indicators used in washing, disinfection and sterilization processes; a system which carries out said method; a method for quantifying cavitation energy in a cavitation indicator subjected to an ultrasonic wash cycle; and a system which carries out said method for quantifying cavitation energy, wherein each of said methods and systems uses an artificial intelligence model to analyze indicators.

### BACKGROUND OF THE INVENTION

Chemical indicators (CIs), according to Association for the Advancement of Medical Instrumentation (AAMI) and International Organization for Standardization (ISO), are devices used to monitor the achievement of one or more of the parameters required for a satisfactory sterilization process or used in a specific test of sterilization equipment. Chemical indicators together with biological indicators and physical monitors must be used as part of a comprehensive quality control program to assure that the conditions for sterilization were met. These chemical indicators are used in different areas of health, food, pharmaceutical and medical products industries, being an essential element in the traceability record of sterilization, washing and disinfection processes.

In general, a chemical indicator consists of a substrate having product information (alphanumeric and/or in barcode, datamatrix, QR or similar format) printed on it and a reactive ink pattern. This reactive ink reacts to the critical parameters of the process cycle for which it was designed. Chemical indicators are based on chemicals that undergo a visible physical or chemical change after being exposed to predetermined critical parameters such as time, temperature, and sterilant. A common example of a physical change in a chemical indicator is a moving front chemical indicator. This indicator consists of a special paper wick and a steam and temperature sensitive chemical pellet contained in a paper/film/foil laminate. The chemical pellet melts and migrates as a dark bar along the paper wick. The migration is visible through a zone marked ACCEPT or REJECT, thus indicating whether sterilization conditions were met. Another type of chemical indicator relies on chemical reactions to bring about a visible change. The chemicals in the indicator ink react to one or more critical parameters of the sterilization process, changing color to indicate whether the conditions have been met.

A different kind of indicator is used to monitor the cavitation process in ultrasonic washers. It consists of a clear vial, with a reactive blue-colored solution and ceramic cylinders immersed in it. It allows testing the operation of ultrasonic washing machines with different washing configurations by measuring the generated cavitation energy. When the cavitation energy is adequate, vibration of the cylinders triggers a color change in the solution, from blue to yellow, through a range of green color intermediates.

If we take into account steam sterilization processes, the personnel in charge includes one or more indicators compatible with the cycle to be performed inside each package, bag, container, tray or other type of container to function as an independent monitor of the critical process parameters. After executing the sterilization cycle, at the time of evaluating the cycle, the indicators placed preliminarily should be accessed, and the information revealed by the reactive ink should be observed and interpreted as specified in the instructions of the product. As a result, the sterilization process may be successful or unsuccessful. In the case of an unsuccessful process, the instrument or material should be subjected to the process again, using a new indicator in the cycle.

Then, the exposed indicators are part of the registration documentation that guarantees the traceability of the materials or instruments treated. These documents mainly contain information on the personnel in charge, the sterilization, washing or disinfection cycle, the package processed and equipment used. The process ends when this information is collected, manually entered in the registry and physically filed for reference when required. This process also applies to the medical, pharmaceutical and food industries, among others.

The above process presents some intrinsic challenges. These are associated with physical and operational features of the systems and, also, of the users of the system.

First of all, the classical interpretation of reactive inks of chemical indicators is usually by ocular observation and subjective, requiring the professional in charge to be highly trained.

Secondly, manual recording of results has some operational disadvantages such as being permeable to human error, which is a point of high risk to the integrity of the process; information is only accessible when records are available and even when records are available, accessing the information can be difficult; the manual process of entering data into the records represents a cost in terms of time and attention of human resources; paper records usually represent a storage cost during the lifetime of the documents; and paper records make data processing and the possibility of analytical statistical analysis difficult; among others.

As a solution to the interpretation of reactive inks of chemical indicators by ocular and subjective observation, and to the manual recording of the results, there are in the prior art patent publications such as U.S. Pat. No. 11,976,964 B2, US 2016/0232421 A1, US 2018/225544 A1, U.S. Pat. No. 6,884,394 B1, WO 2020/009930 A1, US 2017/0191866 A1 disclosing devices and/or methods that include at least some of the following features, capturing images of chemical indicators; some type of processing of the images so as to quantify some feature in said chemical indicators such as reactive ink color change or directly the level of radiation exposure; automatic reading of codes and their decoding; and digitization of the indicators and monitoring and traceability of processes.

However, none of the above mentioned prior art documents includes image processing and analysis techniques that significantly improve the sensitivity and specificity in determining the results of different types of chemical indicators. Additionally, these prior art solutions do not adequately address the specific challenges associated with quantifying cavitation energy in ultrasonic washing processes, where precise colorimetric analysis is critical.

Thus, the state of the art does not provide a solution that combines digitization of the image of an indicator (either chemical indicator or cavitation indicator), advanced processing of such image (such as measuring color, brightness and intensity and that the color is uniform and homogeneous) and automated analysis that allows to extract and record different features of the indicator, allowing high values of sensitivity and specificity in determining the state or result of the indicators, and quantifying cavitation energy through colorimetric changes.

Consequently, there is a need for a method and a system that allows simultaneously the digitalization of the image of the chemical indicator, the advanced processing of said image and its automated analysis so as to extract and record different features of the indicator, thus avoiding both the interpretation by ocular observation and the manual recording of the results, and allowing high values of sensitivity and specificity and, therefore, a correct reading of the state or result of the indicator. In addition, there is a need for a method and a system that allows simultaneously the digitalization of the image of the cavitation indicator, the advanced processing of said image and its automated analysis so as to extract and record different features of the indicator, thus avoiding both the interpretation by ocular observation and the manual recording of the results, and allowing the accurate quantification of cavitation energy during ultrasonic washing processes.

### SUMMARY OF THE INVENTION

Based on the foregoing considerations, the present invention provides a method and system for monitoring chemical indicators used in washing, disinfection and sterilization processes, which allow high sensitivity and specificity in the reading of such results. Additionally, the present invention provides a method and a system for quantifying cavitation energy in a cavitation indicator exposed to an ultrasonic washing cycle, having high accuracy in quantifying said cavitation energy. These methods and systems allow eliminating the subjectivity of the operators; automatically extracting information from the indicators (by applying artificial intelligence models) and uploading it into records; and the information is fully digitized and stored, allowing the traceability of the processes and being able to monitor them locally or remotely.

Accordingly, a first aspect of the present invention is a method for monitoring a washing, disinfection and sterilization process using a chemical indicator, comprising the steps of:
a) locating a two-dimensional reference code on the chemical indicator by reading means, and decoding the two-dimensional reference code so as to validate that the chemical indicator is compatible with processing means;
b) capturing an image of the chemical indicator by the reading means to obtain a digitized image;
c) performing a first cropping of the digitized image by the processing means to keep only the entire chemical indicator and remove unnecessary information;
d) performing a second cropping of the image obtained after the first cropping by the processing means in order to obtain a region of interest of the chemical indicator; and
e) analyzing the region of interest and extracting features of the chemical indicator by the processing means to determine the state of the chemical indicator and the result of the washing, disinfection and sterilization process,
   wherein the processing means uses an artificial intelligence model comprising a convolutional neural network to analyze the region of interest and extract features of the chemical indicator, and to determine the state of the chemical indicator and the result of the washing, disinfection and sterilization process.

In an embodiment of the method of the first aspect of the present invention, the two-dimensional reference code is a datamatrix or a QR code.

In an embodiment of the method of the first aspect of the present invention, in step a) information within the two-dimensional reference code is decoded, said information comprising the indicator type, batch, expiration and date of manufacture.

In an embodiment of the method of the first aspect of the present invention, step c) further comprises rotating the image with respect to the two-dimensional reference code so that the indicator is in a natural reading orientation for its subsequent analysis.

In an embodiment of the method of the first aspect of the present invention, the region of interest comprises the area of the ink reactive to the process to which the chemical indicator was subjected.

In an embodiment of the method of the first aspect of the present invention, the second cropping is performed using image processing techniques, such as blurring, edge detection and color transformations.

In an embodiment of the method of the first aspect of the present invention, between step c) and step d), the geometric factor and the lighting are validated to ensure that the image obtained is correct, and components detected in the image are controlled to be within certain color ranges.

In an embodiment of the method of the first aspect of the present invention, step e) further comprises applying adjustments such as color correction, contrast enhancement and denoising, by means of the processing means, to improve image quality prior to the extraction of the features.

In an embodiment of the method of the first aspect of the present invention, the chemical indicator features obtained are at least one of the presence of reactive ink, the color of the reactive ink, the homogeneity of the color of the reactive ink, the change patterns of the reactive ink, the presence of reflections and/or stains, the color texture and color temperature detected in the image.

In an embodiment of the method of the first aspect of the present invention, the method further comprises the step:
f) digitally recording the result and information of the indicator, allowing local or remote access thereto.

In an embodiment of the method of the first aspect of the present invention, the state of the chemical indicator is determined with a sensitivity above 89% and a specificity above 92%.

A second aspect of the present invention is a system for monitoring a washing, disinfection and sterilization process using a chemical indicator, comprising:
reading means for capturing an image of the chemical indicator; and
processing means in data communication with the reading means, wherein the processing means perform the method according to the first aspect.

In an embodiment of the system of the second aspect of the present invention, the processing means comprise any device capable of processing and/or displaying information, such as a desktop computer, laptop computer, tablet, cell phone, or electronic embedded system.

In an embodiment of the system of the second aspect of the present invention, the processing means allows to directly or indirectly obtain from the digitized image features of the chemical indicator such as color, geometry, homogeneity of the measured surface, color differences, regions of interest, contours and symbolically encoded information.

In an embodiment of the system of the second aspect of the present invention, the system further comprises a display comprising a user interface.

In an embodiment of the system of the second aspect of the present invention, the state of the chemical indicator is determined with a sensitivity above 89% and a specificity above 92%.

A third aspect of the present invention is a method for quantifying cavitation energy in a cavitation indicator subjected to an ultrasonic wash cycle, comprising the following steps:
a) capturing an image of the cavitation indicator using reading means, said image having the cavitation indicator correctly positioned and aligned in a field of view of the reading means, with framing, focus and illumination being verified using processing means;
b) preprocessing the image using the processing means, applying image processing techniques to improve the quality of the image;
c) cropping regions of interest in the image obtained from the previous step by isolating specific areas needed for analysis; and
d) analyzing the regions of interest using the processing means to quantify the cavitation energy in the cavitation indicator,
   wherein the processing means uses an artificial intelligence model comprising a convolutional neural network to analyze the regions of interest and quantify the cavitation energy to which the cavitation indicator was subjected based on colorimetric changes detected.

In an embodiment of the method of the third aspect of the present invention, the image processing techniques comprise at least one of white balance correction, exposure correction, filtering and smoothing, color segmentation, edge detection, color normalization and standardization, color space adjustment, rotation, resizing, color field transformations, contrast adjustment, and color filtering.

In an embodiment of the method of the third aspect of the present invention, the method further comprises the step:
e) digitally recording a cavitation energy result in a database on an external server, allowing local or remote access thereto.

A fourth aspect of the present invention is a system for quantifying cavitation energy in a cavitation indicator subjected to an ultrasonic wash cycle, comprising:
reading means for capturing an image of the cavitation indicator; and
processing means in data communication with the reading means, wherein the processing means perform the method according to the third aspect.

In an embodiment of the system of the fourth aspect of the present invention, the processing means comprise any device capable of processing and/or displaying information, such as a desktop computer, laptop computer, tablet, cell phone, or electronic embedded system.

In an embodiment of the system of the fourth aspect of the present invention, the processing means is a cloud service that uses the artificial intelligence model on the image of the cavitation indicator.

In an embodiment of the system of the fourth aspect of the present invention, the system further comprises a database that enables detailed and accessible test history, traceability, analysis and continuous process improvement.

### BRIEF DESCRIPTION OF THE FIGURES

FIG. 1 shows a digitized image of a chemical indicator after performing the first cropping of the digitized image of the method of the first aspect of the present invention.

FIGS. 2A and 2B show the cropped images obtained from a digitized image after the first cropping and the second cropping of the digitized image of the method of the first aspect of the present invention.

FIGS. 3A to 3E show results obtained using the system of the second aspect of the present invention.

### DETAILED DESCRIPTION OF THE INVENTION

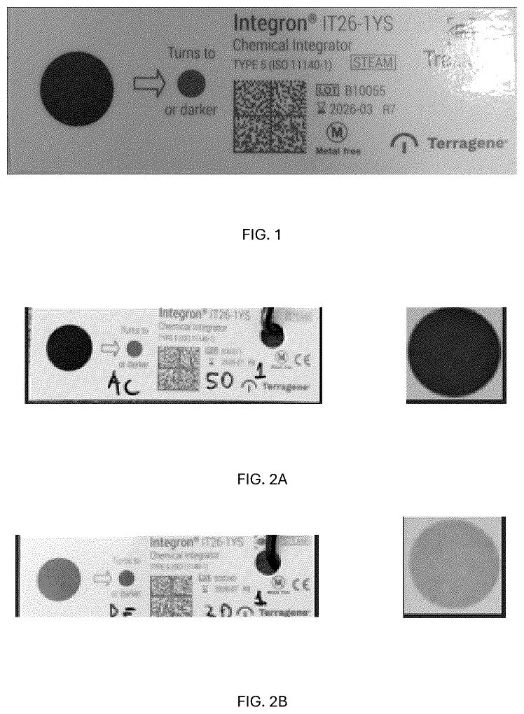

The methods and systems, aspects of the present invention, will be described in detail below with reference to FIGS. 1 to 3E.

As used herein, when referring to a chemical indicator that is used in a “washing, disinfection and sterilization process” or similar, it should be understood that the chemical indicator is used in either a disinfection process, a sterilization process or a washing process, or in a combined disinfection and/or sterilization and/or washing process.

The method of the first aspect of the present invention comprises the steps of locating a two-dimensional reference code on the chemical indicator by reading means, and decoding the two-dimensional reference code so as to validate that the chemical indicator is compatible with processing means; capturing an image of the chemical indicator by the reading means to obtain a digitized image; performing a first cropping of the digitized image by the processing means to keep only the entire chemical indicator and remove unnecessary information; performing a second cropping of the image obtained after the first cropping by the processing means in order to obtain a region of interest of the chemical indicator; and analyzing the region of interest and extracting features of the chemical indicator by the processing means to determine the state of the chemical indicator and the result of the washing, disinfection and sterilization process, wherein the processing means uses an artificial intelligence model comprising a convolutional neural network to analyze the region of interest and extract features of the chemical indicator, and to determine the state of the chemical indicator and the result of the washing, disinfection and sterilization process.

To capture or digitize the chemical indicator, it must be removed from the package, bag, container or tray containing it, and positioned in a suitable way so that the reading means can perform the digitization. In the case of a flatbed type reading means, the entire indicator must be within the surface of the glass of the reading means. In the case of a cell phone, the image capture must completely contain the indicator. Preferably, the method comprises a preconditioning of the reading means and the indicator under analysis to ensure that there are no obstacles that hinder the reading.

Additionally, it is important to verify that the indicator to be analyzed is in good condition and does not present morphological alterations, cuts, rips, tears or other aspects that change its qualities and compromise determining its state.

The locating of the position of the two-dimensional reference code on the chemical indicator is performed automatically. This two-dimensional reference code is a datamatrix or a QR code encoded by the GSI standard and containing information relative to the chemical indicator.

The information (e.g. type of indicator, batch, expiration date, date of manufacture, etc.) obtained from this decoding serves as a process control point since it validates that the chemical indicator is compatible with the processing means being used and that it complies with the coding standard. This validation is carried out by comparing the information obtained from decoding with reference data. In addition, the integrity of the two-dimensional reference code within the image is verified.

Decoding to identify the chemical indicator may be performed by an application on a computing device (e.g., a mobile device), wherein said device may comprise the processing means.

Regarding the first cropping, the image is rotated with respect to the two-dimensional reference code so that the indicator is in a natural reading orientation for subsequent analysis. Regarding the second cropping, the region of interest comprises the area of the ink reactive to the process to which the corresponding chemical indicator was subjected.

The second cropping is performed using image processing techniques, such as blurring, edge detection, and color transformations. These techniques allow enhancing the quality and highlighting key features in the images, which results in being able to identify and isolate specific components in such images such as objects, contours, or regions of interest.

Before obtaining the region of interest and detecting components in the image, specifically, between performing the first cropping and the second cropping, the geometric factor, geometrical deformations, brightness, and the lighting are validated (comparing them to reference data) to ensure that the image obtained is correct, and the components are checked to ensure that they are within certain color ranges. Regarding lighting, lighting can be corrected by means of a homomorphism filter that separates illumination and reflectance, normalizing the lighting conditions. In addition, Gaussian and median filters can be used to smooth the image and reduce noise without losing important details.

To obtain the region of interest, the processing means carries out segmentation techniques, such as edge-based segmentation where the Canny operator can be used to detect edges and segment the indicator region of interest; or region-based segmentation where region growing is used to segment contiguous areas that meet similarity criteria (circles, logos, etc).

It should be noted that the region of interest is extracted for its particular analysis which is essential to reduce the computational workload and the use of resources by reducing the amount of data to be processed, thus improving the speed and efficiency of the processing means. Additionally, the accuracy of the analysis is increased by focusing on relevant data, which facilitates the implementation of simpler and more specific algorithms.

At the step of analyzing the region of interest and extracting chemical indicator features, adjustments such as color correction, contrast enhancement, and denoising are applied to improve image quality prior to the extraction of the features. With respect to said chemical indicator features, these are at least one of the presence of reactive ink, the color of the reactive ink, the homogeneity of the color of the reactive ink, the change patterns of the reactive ink, the presence of reflections and/or stains, the color texture and the color temperature detected in the image, among others. This feature extraction from the images, which is performed using digital image processing techniques (known or customized), allows characterization of the chemical indicator. Alternatively, it can be characterized through an automatic training process using machine learning techniques.

These features are crucial inputs for advanced classification and recognition processes that employ machine learning techniques, including support vector machines (SVM) to classify images based on color and texture features; and convolutional neural networks (CNN) for automatic and robust pattern recognition in images.

The presence of reactive ink is extracted by thresholding and pixel counting. In particular, a threshold is used to segment the region containing ink in the image. Techniques such as Otsu's method can be applied to automatically determine the optimal threshold. Subsequently, the number of pixels in the segmented region is counted, where a significant number of pixels indicates the presence of ink.

The color of the reactive ink is extracted either by analyzing the color, where the HSV color model can be used to extract the hue component to determine the predominant color of the ink in the image; or by calculating the color histogram of the ink region and finding the dominant peak that represents the color of the ink.

The color homogeneity of the reactive ink is extracted by first calculating the standard deviation of the hue component in the reactive ink region, where a low standard deviation indicates color homogeneity; and then dividing the standard deviation by the mean of the hue component to obtain a normalized measure of color homogeneity.

The presence of reflections is extracted by analyzing brightness, for which the LAB color space can be used and the L (luminance) component analyzed to detect bright areas that could indicate the presence of reflections. Alternatively, the presence of reflections can be obtained by applying adaptive thresholding to separate bright and dark regions to determine if reflections are present.

The color temperature is extracted using, for example, the LAB or RGB color space which allows the color temperature of the region of interest to be calculated. This can be done by analyzing the color components and comparing them with a color temperature reference table.

The color texture is extracted using, for example, gray level co-occurrence matrices, wherein said matrices allow the extraction of texture features that can influence the determination of the state of the indicator.

Additionally, from the extraction of features of the chemical indicator, the result of whether the process (e.g. washing, disinfection or sterilization) in which it was used was successful or unsuccessful is determined by means of the processing means comprising the artificial intelligence model comprising a convolutional neural network.

It should be noted that the resulting features obtained allow feeding different types and topologies of neural networks (single/multiple perception networks, convolutional neural networks, recurrent neural network), as mentioned above, so as to speed up the results of readings and analysis of future chemical indicators.

The artificial intelligence model used by the processing means is previously trained. This training is carried out by capturing images in uncontrolled environments of chemical indicators used in washing, disinfection and sterilization processes. The process involves the use of multispectral cameras that capture images in multiple spectra (RGB, infrared) to obtain a more comprehensive view of the indicators. These images are captured under variable lighting conditions, including both natural and artificial light, at different times of the day to simulate realistic environments. A large dataset is collected, for example, consisting of at least 5000 images captured under diverse conditions (variations in lighting, camera angles, the presence of shadows, different backgrounds, and potential visual interference) and environments to ensure a representative and robust database which is used as a reference database (of standard colors) as shown below.

To determine whether the process (e.g. washing, disinfection or sterilization) in which the chemical indicator was used was successful or unsuccessful, the extracted features are compared against the reference database that indicates the possible states of the indicator. This comparison is essential for ensuring that the assessment of the results aligns with predefined standards. Additionally, to enhance the accuracy of this assessment, algorithms that simulate human visual perception are implemented. These algorithms utilize visual perception models, such as CIEDE2000, to measure differences in color, thus ensuring that the automatic results obtained are consistent with how the human eye would perceive reactive ink.

The advantages of using the artificial intelligence model with convolutional neural networks are their high accuracy in classification and pattern recognition tasks, especially in visual and spatial data; the automatic extraction of relevant features; scalability as such networks can handle large volumes of data and can be scaled to work with massive datasets without a significant decrease in performance; adaptability as they are versatile and can be applied to a variety of problems, not only in images, but also in time series and other types of structured data; and reduce human error, where by automating the analysis and classification process, errors that may arise from subjective human judgment are reduced.

The method of the first aspect of the present invention can further comprise a step of digitally recording the result and information of the indicator, allowing local or remote access thereto. In this step the result is uploaded to, for example, a cloud by sending the information over the internet, making use of cloud services. The image with the indicator is sent, together with metadata of the indicator, ensuring its information, result and traceability of the process performed during the sampling. All this data can be sent back to the application for viewing and notification of a user.

Referring to the system of the second aspect of the present invention, this system comprises reading means allowing to capture an image of a chemical indicator; and processing means in data communication with the reading means, wherein the processing means allow to carry out the method of the first aspect of the present invention.

The reading means is any device capable of capturing in a digital image the object of analysis (i.e., the chemical indicator) in whole or in part, such as cameras, mobile devices with cameras, scanners or any device designed to take digital images.

The processing means can be any device capable of processing and/or displaying information, such as a desktop computer, laptop, tablet, cell phone, electronic embedded system, external server, web server, etc. The processing means allows obtaining directly or indirectly from the digitized image of the indicator features of the chemical indicator such as color, geometry, homogeneity of the measured surface, color differences, regions of interest, contours and symbolically encoded information (data-matrix, QR), among others.

The system of the second aspect of the present invention further comprises a display comprising a user interface. This display allows for on-the-fly viewing of the result of the digitization and automatic analysis, and automatically reading indicator information (e.g., type, batch, expiration, etc.) for recording. It also allows the registration of the chemical indicator to be completed with additional information.

The system of the second aspect of the present invention can then take an image of the chemical indicator, digitize it and analyze its color (in the reactive ink area) objectively by means of machine learning mechanisms, replicating the visual analysis made by the user and eliminating possible interpretation errors associated with the human factor. As will be apparent the reading means, the processing means and the display may be comprised in the same computing device such as a desktop or laptop computer, a mobile device (e.g. cell phone or tablet) or other electronic device that can implement the method of the present invention and achieve a degree of automation suitable for mass monitoring of sterilization, washing or disinfection processes.

The system of the second aspect of the present invention enables the digitization, traceability and automatic analysis of the efficiency of sterilization and washing processes by means of machine vision determination of chemical indicators. To this end, the processing means uses an artificial intelligence model comprising a convolutional neural network, as described above for the method for monitoring washing, disinfection and sterilization processes using chemical indicators, which enables a user of the system of the second aspect of the present invention to automatically analyze the results of a process expressed by a chemical indicator. More precisely, this automatic analysis is possible, thanks to the employment of automatic learning algorithms, which replicate in the hands of the user of the system of the second aspect of the present invention the visual analysis performed by a skilled human.

The system of the second aspect can, for example, be used by a user as follows. The user focuses on the chemical indicator and when the camera (e.g., the camera of a mobile device) detects the two-dimensional reference code, it is automatically decoded and the capture of an image of the chemical indicator is automatically triggered. Depending on the data obtained from the two-dimensional reference code the first cropping is performed and the user sees the image cropped to the boundaries of the indicator in a display of the mobile device. All the data obtained from the reading of the two-dimensional reference code is validated and, optionally, together with the image obtained from the first cropping, it is indicated whether the indicator is compatible with the processing means. Then the mobile device application allows sending the image obtained after the first cropping to, for example, an API that is on a web server comprising artificial intelligence models (i.e., said web server with artificial intelligence models acts as processing means). When the image is received, it is resized and conditioned, and then the image is validated for lighting, brightness, geometrical deformations, etc. If the image passes the validations, the second cropping (of the region of interest) is performed and analyzed with the artificial intelligence model. Finally, the result is returned to the application so that the system of the second aspect displays it to the user.

Regarding the method for quantifying cavitation energy in a cavitation indicator subjected to an ultrasonic wash cycle, according to the third aspect of the present invention, said method comprises the steps of capturing an image of the cavitation indicator using reading means, said image having the cavitation indicator correctly positioned and aligned in a field of view of the reading means, with framing, focus and illumination being verified using processing means; preprocessing the image using the processing means, applying image processing techniques to improve the quality of the image; cropping regions of interest in the image obtained from the previous step by isolating specific areas needed for analysis; and analyzing the regions of interest using the processing means to quantify the cavitation energy in the cavitation indicator, wherein the processing means uses an artificial intelligence model comprising a convolutional neural network to analyze the regions of interest and quantify the cavitation energy to which the cavitation indicator was subjected based on colorimetric changes detected.

As it is apparent to a person skilled in the art, before capturing an image of the cavitation indicator, it is necessary to verify that the cavitation indicator does not show morphological alterations, i.e. that there are no visible cracks or breaks that could lead to spillage of the solution contained by the vial.

In relation to image processing techniques, white balance correction is used to adjust the colors of the image so that white objects appear truly white, regardless of the color temperature of the light. This is crucial to ensure that colors are accurately reproduced in captured images, especially in environments with different light sources.

Exposure correction is used to adjust the exposure level in images, ensuring that they are correctly exposed. This is important to avoid overexposed or underexposed images, which could adversely affect color measurement.

Filtering and smoothing techniques are used to reduce noise and imperfections in images. This may include the use of filters such as the Gaussian filter or median filter to remove noise and improve image quality.

Color segmentation is used to divide an image into regions based on color. This can be useful for isolating objects or areas of interest in the image, which facilitates more accurate color analysis.

Edge detection is used to identify the edges of objects in an image. This can be useful for highlighting important features in the image and improving object segmentation.

Color normalization and standardization are used to ensure that color data is consistent and comparable between different images and lighting environments. This can help improve the accuracy of color measurement.

Color space adjustment involves conversion between different color spaces, such as RGB and HSV. This can be useful for highlighting certain color characteristics or simplifying color analysis in images.

The artificial intelligence model used by the processing means is previously trained. This training is performed by acquiring images of the cavitation indicator using reading means and employing object detection models to identify and locate the cavitation indicator in such images in real time. More precisely, the use of such object detection models comprises assembling a dataset of images of interest, labeling each of the images of interest in the dataset so as to obtain labeled images of interest; converting the labeled images of interest into a format compatible with the detection models so as to obtain converted images; and training the detection models using the converted images so as to obtain a detection model trained to identify and locate the cavitation indicator in the images in real time. At the end of the training, the artificial intelligence model is able to accurately determine the amount of cavitation energy from new cavitation indicator images it receives.

Therefore, the methods and systems of the present invention allow advantages such as allowing automatic certified results, eliminating operator subjectivity; automatically extracting information from the indicator and uploading it into records; allowing the information to be fully digitized and stored, allowing the traceability of the processes and being able to monitor them locally or remotely.

Additionally, the systems of the present invention are adaptable to different installations and allow differentiated access for different user profiles and also allow digital, reliable, secure, unalterable and locally or remotely accessible records; the possibility of exporting records to be physically printed on paper; visualizing statistics about the indicators and generating reports.

### EXPERIMENTAL RESULTS

Experimental results of the method and system of the first and second aspect of the present invention are shown below, verifying their correct performance.

In FIG. 1 it can be seen how a digitized image of the chemical indicator looks like after the first cropping performed by the processing means. In particular, it can be seen how the indicator is correctly rotated and cropped.

In FIGS. 2A and 2B can be seen the cropping obtained from a digitized image after performing the first cropping and the second cropping by means of the processing means. In particular, on the left of both FIGS. 2A and 2B it can be seen how the digitized image looks like after the first cropping, where it can be seen that said first cropping obtains the whole chemical indicator; while on the right of both FIGS. 2A and 2B it can be seen how the digitized image looks like after the second cropping, where it can be seen that said second cropping obtains the region of interest to be analyzed, being in this case the reactive ink area.

Below, results are shown that allow measuring the validity and reliability of the automatic readings performed by the system of the second aspect of the present invention. Tables 1 and 2 show respectively the hardware and software used, and Table 3 shows the chemical indicators used.

TABLE 1
Hardware used

| Device | Quantity | Serial number |
|---|---|---|
| Samsung Galaxy S9 | 1 | R28K51CPFNF |

TABLE 2

| Software used | Version |
|---|---|
| Trazanto Lens | 240125 |

TABLE 3
Representative product samples

| Chemical | Equipment | | | |
|---|---|---|---|---|
| indicator | [Brand- | | Quantity | Batches |
| [Code] | model] | Cycle | [units] | [Code] |
| CD40 | CASP 50-flash | SAFE: 6 min 50° C. | 300 | B30628 |
| | | 2.3 mg/L VH2O2 | | B30629 |
| | | UNSAFE: 4 min 50° C. | | B30630 |
| | | 2.3 mg/L VH2O2 | | |
| CD42 | CASP 50-flash | SAFE: 6 min 50° C. | 300 | B20521 |
| | | 2.3 mg/L VH2O2 | | B30395 |
| | | UNSAFE: 7 sec 50° C. | | B30440 |
| | | 2.3 mg/L VH2O2 | | |
| CDWA4 | Washer Melag - | SAFE: 5 min at 50° C. | 300 | B30562 |
| | MelaTherm 10 | with 4 ml/l de | | B30593 |
| | | detergent | | B30608 |
| | | Water 80 ppm. | | |
| | | UNSAFE: 5 min at | | |
| | | 50° C. without | | |
| | | detergent, | | |
| | | water 80 ppm | | |
| IT26-1YS | RESISTOMETER | SV time declared for | 300 | B30554 |
| | LAUTENSCHLAG | each batch, temperature: | | B30555 |
| | ER 2320 | SAFE: 135° C. | | B30620 |
| | | UNSAFE: 134° C. | | |
| IT26-C | RESISTOMETER | SV time declared | 300 | B30331 |
| | LAUTENSCHLAG | for each batch, | | B30551 |
| | ER 2320 | temperature: | | B30595 |
| | | SAFE: 135° C. | | |

It should be understood that the SAFE, POSITIVE or ACCEPTED state of a chemical indicator refers to the state of the indicator undergoing the sterilization/washing/disinfection process for which it was designed, when the reactive ink turns (changes color or is completely removed) as indicated in its instructions. Conversely, the non-variation condition of the reagent ink is defined as UNSAFE, NEGATIVE or REJECTED.

Additionally, it should be understood that the expression “ground truth” refers to information that is known to be true or real. The ground truth is taken as a reference to compare against the automatic results obtained by means of the method and system of the first and second aspect of the present invention.

Accordingly, a TRUE SAFE or TRUE POSITIVE (TP) is obtained when the indicators that were automatically detected as SAFE by the system of the second aspect of the present invention, are also SAFE in the ground truth. This represents a correct reading and determination of the indicator state (i.e., indicator result) by the system of the second aspect of the present invention.

A TRUE UNSAFE or TRUE NEGATIVE (TN) is obtained when indicators that were automatically detected as UNSAFE by the system of the second aspect of the present invention are also UNSAFE in the ground truth. This represents a correct reading and determination of the indicator state by the system of the second aspect of the present invention.

A FALSE SAFE or FALSE POSITIVE (FP) is obtained when indicators that were automatically detected as SAFE by the system of the second aspect of the present invention, are UNSAFE in the ground truth. This represents an incorrect reading and determination of UNSAFE indicators by the system of the second aspect of the present invention. This condition generally occurs in processes which led the indicator to a near total color shift of the reactive ink.

Finally, a FALSE UNSAFE or FALSE NEGATIVE (FN) is obtained when indicators that were automatically detected as UNSAFE by the system of the second aspect of the present invention, are SAFE in the ground truth. This represents an incorrect reading and determination of SAFE indicators by the system of the second aspect of the present invention. This condition generally occurs in processes which led the indicator to a near total color shift of the reactive ink.

For the case of chemical indicators, the impact of having a false negative (FN) is less than that of having a false positive (FP), since a false negative suggests the reprocessing of the material to be sterilized or washed giving the possibility of confirmation of the correct result. On the other hand, a false positive result does not indicate the need for reprocessing and is therefore a riskier situation.

It should be noted that the predictive value of the system indicates the probability of having a correct automatic reading result, i.e., the efficiency of the system. Therefore, the positive predictive value (PPV), which indicates the probability of having a true positive result, was taken as the validation parameter. Additionally, the positive predictive value is expected to be greater than or equal to the negative predictive value (NPV), which indicates the probability of having a true negative result. Therefore, to evaluate the validity and reliability of the automatic readings performed by the system of the second aspect of the present invention, the following two conditions are taken into account:

$$PPV \geq 90 \% \qquad Condition C1$$

$$PPV \geq NPV \qquad Condition C2$$

where the way the PPV and NPV values are obtained is shown below:

$$Positive predictive value or PPV ( \% ) = \frac{TP \cdot 100}{TP + FP}$$

$$Negative predictive value or NPV ( \% ) = \frac{TN \cdot 100}{TN + FN}$$

The results using the system of the second aspect of the present invention on the chemical indicators in Table 3 are shown below. A total of 1500 independent automatic analysis tests were performed with the system of the second aspect of the present invention. Particularly, chemical indicators CD40 and CD42 were used in hydrogen peroxide sterilization tests; chemical indicators IT26-C and IT26-1YS were used in steam sterilization tests; and chemical indicators CDWA4 were used in washing tests.

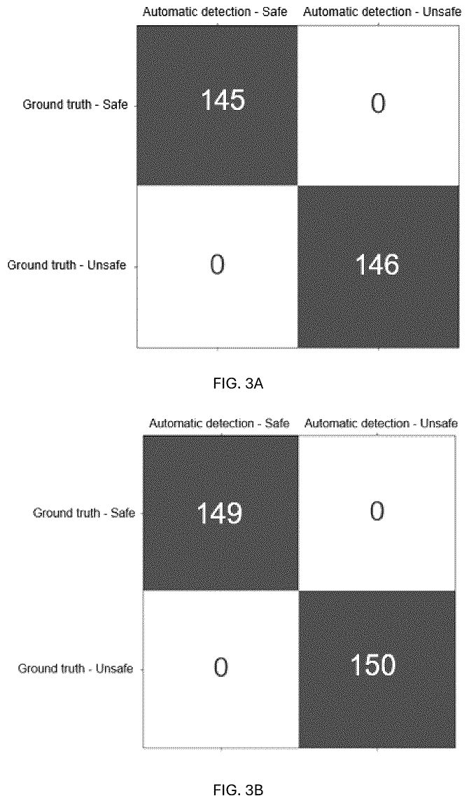

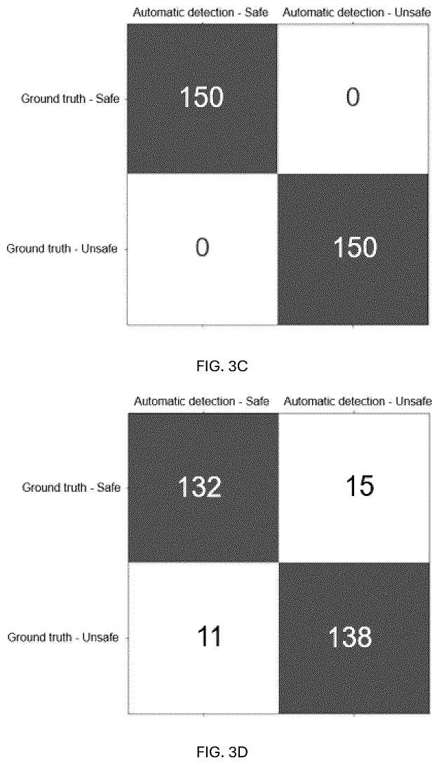

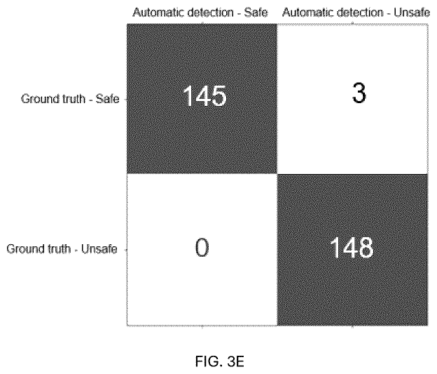

For the chemical indicator CD40, 145 true positive-type detections and 146 true negative-type detections were obtained (9 indicators were not considered as they did not pass validation). These results are illustrated in FIG. 3A which corresponds to an image displayed by the system of the second aspect of the present invention. In particular, a PPV of 100% and a NPV of 100% were obtained, thus conditions C1 and C2 were met and, consequently, the automatic readings performed by the system of the second aspect of the present invention are valid and reliable.

Additionally, considering the following equations for sensitivity and specificity:

$$Sensitivity ( \% ) = \frac{TP \cdot 100}{TP + FN}$$

$$Specificity ( \% ) = \frac{TN \cdot 100}{TN + FP}$$

both a sensitivity of 100% and a specificity of 100% were obtained.

For the chemical indicator CD42, 149 true positive-type detections and 150 true negative-type detections were obtained (1 indicator was not considered as it did not pass validation). These results are illustrated in FIG. 3B which corresponds to an image displayed by the system of the second aspect of the present invention. In particular, a PPV of 100% and a NPV of 100% were obtained, thus conditions C1 and C2 were met and, consequently, the automatic readings performed by the system of the second aspect of the present invention are valid and reliable. Additionally, both a sensitivity of 100% and a specificity of 100% were obtained.

For the chemical indicator CDWA4, 150 true positive-type detections and 150 true negative-type detections were obtained. These results are illustrated in FIG. 3C which corresponds to an image displayed by the system of the second aspect of the present invention. In particular, a PPV of 100% and a NPV of 100% were obtained, thus conditions C1 and C2 were met and, consequently, the automatic readings performed by the system of the second aspect of the present invention are valid and reliable. Additionally, both a sensitivity of 100% and a specificity of 100% were obtained.

For the chemical indicator IT26-1YS, 132 true positive-type detections, 138 true negative-type detections, 11 false positive-type detections and 15 false negative-type detections were obtained (4 indicators were not considered as they did not pass validation). These results are illustrated in FIG. 3D which corresponds to an image displayed by the system of the second aspect of the present invention. In particular, a PPV of 92.3% and a NPV of 90.2% were obtained thus conditions C1 and C2 were met and, consequently, the automatic readings performed by the system of the second aspect of the present invention are valid and reliable. Additionally, a sensitivity of 89.8% and a specificity of 92.6% were obtained.

Finally, for the chemical indicator IT26-C, 145 true positive-type detections, 148 true negative-type detections and 3 false negative-type detections were obtained (4 indicators were not considered as they did not pass validation). These results are illustrated in FIG. 3E which corresponds to an image displayed by the system of the second aspect of the present invention. In particular, a PPV of 100% and a NPV of 98% were obtained, thus conditions C1 and C2 were met and, consequently, the automatic readings performed by the system of the second aspect of the present invention are valid and reliable. Additionally, a sensitivity of 98% and a specificity of 100% were obtained.

### Example of Training the Artificial Intelligence Model for Cavitation Energy Quantification

To train the artificial intelligence model used to quantify the cavitation energy in a cavitation indicator, the following procedure was used.

A convolutional neural network (CNN) classifier was used, and the training process involved generating a comprehensive dataset of images of the cavitation indicator (e.g., the CDWU/Z indicator). The dataset was created by exposing batches of indicators to controlled ultrasonic wash cycles under various conditions.

The only accepted result after exposure is when it turns yellow, therefore the minimum exposure must be determined, at conditions expressed in the technical specifications of the indicator, by which the final accepted state is reached. Once this condition is reached, absorbance/transmittance is measured using a spectrophotometer. This point is critical, since it guarantees that the indicator has been exposed to sufficient cavitation energy to reach the desired condition.

Ten intermediate time windows were defined and batches of 10 indicators were exposed at each of the determined times. After exposure, absorbance/transmittance is measured with the device.

At this step there are 10 exposed batches and their respective absorbance measurements. Assuming that the cavitation energy emitted by the ultrasonic washer is constant, the measured absorbance can be related to the received energy.

The 10 batches of indicators were digitized using images captured by a camera. This digitization of the indicators seeks to isolate the information provided by the reactive solution from the noise that the different light conditions and the background of the image may provide. To achieve an effective digitization, multiple scenarios were established by combining the following parameters: natural light and artificial light with four different color temperatures (from 4000K to 10000K), and nine background colors (seven primary colors, black and white). This combination resulted in a total of 5 light conditions, 9 background colors, 10 time windows and 10 indicators per batch, thus obtaining 4500 images.

These images were used to train the convolutional neural network. The network architecture included 10 input neurons corresponding to the different exposure time classes, hidden layers to process the image features, and 10 output neurons with a softmax activation function to obtain the degrees of membership in each class. The neural network learned to classify the indicator images based on the different exposure conditions, providing a robust and accurate tool. In this way, the cavitation energy received by the indicator was inferred by a correlation established by artificial intelligence with an accurate absorbance measurement.

This procedure ensures a rigorously trained model capable of accurately distinguishing between the different states of the indicator and assessing the effectiveness of the ultrasonic cleaning process.

1. A method for monitoring a washing, disinfection and sterilization process using a chemical indicator, comprising the steps of:
a) locating a two-dimensional reference code on the chemical indicator by reading means, and decoding the two-dimensional reference code so as to validate that the chemical indicator is compatible with processing means;
b) capturing an image of the chemical indicator by the reading means to obtain a digitized image;
c) performing a first cropping of the digitized image by the processing means to keep only the entire chemical indicator and remove unnecessary information;
d) performing a second cropping of the image obtained after the first cropping by the processing means in order to obtain a region of interest of the chemical indicator; and
e) analyzing the region of interest and extracting features of the chemical indicator by the processing means to determine the state of the chemical indicator and the result of the washing, disinfection and sterilization process,
wherein the processing means uses an artificial intelligence model comprising a convolutional neural network to analyze the region of interest and extract features of the chemical indicator, and to determine the state of the chemical indicator and the result of the washing, disinfection and sterilization process.

2. The method according to claim 1, wherein the two-dimensional reference code is a datamatrix or a QR code.

3. The method according to claim 1, wherein in step a) information within the two-dimensional reference code is decoded, said information comprising the indicator type, batch, expiration and date of manufacture.

4. The method according to claim 1, wherein step c) further comprises rotating the image with respect to the two-dimensional reference code so that the indicator is in a natural reading orientation for its subsequent analysis.

5. The method according to claim 1, wherein the region of interest comprises the area of the ink reactive to the process to which the chemical indicator was subjected.

6. The method according to claim 1, wherein the second cropping is performed using image processing techniques, such as blurring, edge detection and color transformations.

7. The method according to claim 1, wherein between step c) and step d), the geometric factor and the lighting are validated to ensure that the image obtained is correct, and components detected in the image are controlled to be within certain color ranges.

8. The method according to claim 1, wherein step e) further comprises applying adjustments such as color correction, contrast enhancement and denoising, by means of the processing means, to improve image quality prior to the extraction of the features.

9. The method according to claim 1, wherein the chemical indicator features obtained are at least one of the presence of reactive ink, the color of the reactive ink, the homogeneity of the color of the reactive ink, the change patterns of the reactive ink, the presence of reflections and/or stains, the color texture and color temperature detected in the image.

10. The method according to claim 1, further comprising the step:
f) digitally recording the result and information of the indicator, allowing local or remote access thereto.

11. The method according to claim 1, wherein the state of the chemical indicator is determined with a sensitivity above 89% and a specificity above 92%.

12. A system for monitoring a washing, disinfection and sterilization process using a chemical indicator, comprising:
reading means for capturing an image of the chemical indicator; and
processing means in data communication with the reading means, wherein the processing means perform the following steps:
locating a two-dimensional reference code on the chemical indicator by reading means, and decoding the two-dimensional reference code so as to validate that the chemical indicator is compatible with processing means;
capturing an image of the chemical indicator by the reading means to obtain a digitized image;
performing a first cropping of the digitized image by the processing means to keep only the entire chemical indicator and remove unnecessary information;
performing a second cropping of the image obtained after the first cropping by the processing means in order to obtain a region of interest of the chemical indicator; and
analyzing the region of interest and extracting features of the chemical indicator by the processing means to determine the state of the chemical indicator and the result of the washing, disinfection and sterilization process,
wherein the processing means uses an artificial intelligence model comprising a convolutional neural network to analyze the region of interest and extract features of the chemical indicator, and to determine the state of the chemical indicator and the result of the washing, disinfection and sterilization process.

13. The system according to claim 12, wherein the processing means allows to directly or indirectly obtain from the digitized image features of the chemical indicator such as color, geometry, homogeneity of the measured surface, color differences, regions of interest, contours and symbolically encoded information.

14. The system according to claim 12, wherein the state of the chemical indicator is determined with a sensitivity above 89% and a specificity above 92%.

15. A method for quantifying cavitation energy in a cavitation indicator subjected to an ultrasonic wash cycle, comprising the following steps:
a) capturing an image of the cavitation indicator using reading means, said image having the cavitation indicator correctly positioned and aligned in a field of view of the reading means, with framing, focus and illumination being verified using processing means;
b) preprocessing the image using the processing means, applying image processing techniques to improve the quality of the image;
c) cropping regions of interest in the image obtained from the previous step by isolating specific areas needed for analysis; and
d) analyzing the regions of interest using the processing means to quantify the cavitation energy in the cavitation indicator,
wherein the processing means uses an artificial intelligence model comprising a convolutional neural network to analyze the regions of interest and quantify the cavitation energy to which the cavitation indicator was subjected based on colorimetric changes detected.

16. The method according to claim 15, wherein the image processing techniques comprise at least one of white balance correction, exposure correction, filtering and smoothing, color segmentation, edge detection, color normalization and standardization, color space adjustment, rotation, resizing, color field transformations, contrast adjustment, and color filtering.

17. The method according to claim 15, wherein the method further comprises the step:
e) digitally recording a cavitation energy result in a database on an external server, allowing local or remote access thereto.

18. A system for quantifying cavitation energy in a cavitation indicator subjected to an ultrasonic wash cycle, comprising:
reading means for capturing an image of the cavitation indicator; and
processing means in data communication with the reading means, wherein the processing means perform the following steps:
capturing an image of the cavitation indicator using reading means, said image having the cavitation indicator correctly positioned and aligned in a field of view of the reading means, with framing, focus and illumination being verified using processing means;
preprocessing the image using the processing means, applying image processing techniques to improve the quality of the image;
cropping regions of interest in the image obtained from the previous step by isolating specific areas needed for analysis; and
analyzing the regions of interest using the processing means to quantify the cavitation energy in the cavitation indicator,
wherein the processing means uses an artificial intelligence model comprising a convolutional neural network to analyze the regions of interest and quantify the cavitation energy to which the cavitation indicator was subjected based on colorimetric changes detected.

19. The system according to claim 18, wherein the processing means is a cloud service that uses the artificial intelligence model on the image of the cavitation indicator.

20. The system according to claim 18, wherein the system further comprises a database that enables detailed and accessible test history, traceability, analysis and continuous process improvement.
